(19) United States
(12) Patent Application Publication
(10) Pub. No.: US 2026/0026521 A1
(43) Pub. Date: Jan. 29, 2026

(54) METHOD FOR THAWING FROZEN GRATED DAIKON RADISH

(71) Applicant: KOGAWA CO., LTD., Tokyo (JP)

(72) Inventor: Masayoshi KOGAWA, Tokyo (JP)

(21) Appl. No.: 19/277,911

(22) Filed: Jul. 23, 2025

(30) Foreign Application Priority Data
Jul. 29, 2024 (JP) 2024-122422
Oct. 15, 2024 (JP) 2024-179692

(51) Int. Cl. A23B 7/055; A23B 2/779; A23B 7/045; A23L 19/10

(52) U.S. Cl. CPC A23B 7/055; A23B 2/779; A23B 7/045; A23L 19/10

(57) ABSTRACT

There is provided a method for thawing frozen grated daikon radish that can reliably suppress the release of moisture from grated daikon radish after thawing, and that does not cause impairment of texture due to viscosity (stickiness). In the present invention, when the frozen grated daikon radish is thawed, distarch phosphate and hydroxypropyl distarch phosphate are added in the range of 2 to 10% by mass in total with respect to the entire amount of the frozen grated daikon radish.

### BACKGROUND OF THE INVENTION

### Field of the Invention

The present invention relates to a method for thawing frozen grated daikon radish.

### Description of the Related Art

In recent years, as the family structure has changed from the traditional large family to the nuclear family, and as the number of singles, employees posted away from their families, etc., has increased, the style of meals has also changed. For example, families no longer eat together at the same time around the dining table, and each family member eats at a different time according to his or her own schedule. In such cases, various types of frozen foods are often used as side dishes, as it is more convenient to prepare individual portions for each family member rather than cooking a whole family's worth of food at once.

Considering grated daikon radish, for example, as an example of the side dishes, grated daikon radish can be eaten only by cutting off the leaves and other unnecessary parts of a daikon radish purchased at a grocery store or the like, removing the skin from the root portion, and then grating it down. When purchased as a whole, a daikon radish has a considerable weight, and bringing it back home and cooking it as described above is burdensome for singles and those posted away from their families. In this regard, since the frozen foods are cooked in advance, they can be eaten immediately by thawing naturally, cold water thawing, or the like.

Therefore, frozen grated daikon radish formed by removing the skin of the root portion, grating it, and freezing it in advance has been proposed. As for the frozen grated daikon radish, conventionally, daikon radishes harvested in the place of production are conveyed to a factory, where the root portions, with leaves and other unnecessary parts removed, are washed, peeled, sterilized, and then processed into a grated shape using a grating machine or other equipment. When grating the root portions of daikon radishes, so-called grated daikon radish, in which the root portions are subdivided into small fibrous pieces, is obtained, and the intracellular moisture comes out from the cells that have been destroyed by the subdivision.

Although some of the moisture is retained in the grated daikon radish and eaten, that not retained is discarded as excess moisture. Thus, conventional frozen grated daikon radish is made by bagging and freezing the grated daikon radish in a state where the excess moisture has been discarded, as it is.

However, a problem of the frozen grated daikon radish is that when the frozen grated daikon radish is thawed, the moisture is further released and the yield decreases, while the freshness is lost and the ratio of fiber content increases, resulting in impairment of texture. In order to solve the above problem, the present applicant has proposed frozen grated daikon radish comprising grated daikon radish that is obtained by grating the root portion of a daikon radish and retains a predetermined moisture content, and carboxymethyl cellulose (see Japanese Patent No. 3425932).

According to the frozen grated daikon radish described in Japanese Patent No. 3425932, it is difficult for moisture to be released when the frozen grated daikon radish is thawed, and excellent texture can be obtained even after thawing.

However, the frozen grated daikon radish described in Japanese Patent No. 3425932 may have the disadvantage that it is difficult to achieve the effect of preventing moisture from being released when thawed. On the other hand, in order to solve the above disadvantage, increasing the amount of carboxymethyl cellulose added results in viscosity (stickiness), which poses the disadvantage of impaired texture, and improvement is desired.

In view of such circumstances, an object of the present invention is to provide a method for thawing frozen grated daikon radish that can reliably suppress the release of moisture from grated daikon radish after thawing, and that can provide grated daikon radish not causing impairments in texture due to viscosity (stickiness).

### SUMMARY OF THE INVENTION

In order to achieve the object, a method for thawing frozen grated daikon radish of the present invention is a method for thawing frozen grated daikon radish formed by freezing grated daikon radish that is obtained by grating a root portion of a daikon radish and retains a predetermined moisture content, characterized in that when the frozen grated daikon radish is thawed, distarch phosphate and hydroxypropyl distarch phosphate are added in the range of 2 to 10% by mass in total with respect to the entire amount of the frozen grated daikon radish.

According to the method for thawing frozen grated daikon radish of the present invention, when the frozen grated daikon radish is thawed, distarch phosphate and hydroxypropyl distarch phosphate are added in the amounts in the above range with respect to the entire amount of the frozen grated daikon radish, thus allowing the release of moisture from grated daikon radish after thawing to be reliably suppressed and even the moisture that would otherwise be released to be consumed as grated daikon radish. In addition, according to the method for thawing frozen grated daikon radish of the present invention, grated daikon radish can be obtained with no impairment of texture due to viscosity (stickiness).

In the method for thawing frozen grated daikon radish of the present invention, only the addition of distarch phosphate is not sufficient to suppress the release of moisture from grated daikon radish after thawing, and in order to reliably suppress the release of moisture from grated daikon radish after thawing, it is necessary to use distarch phosphate and hydroxypropyl distarch phosphate in combination.

In the method for thawing frozen grated daikon radish of the present invention, if the amount of distarch phosphate and hydroxypropyl distarch phosphate added with respect to the entire amount of the frozen grated daikon radish is less than 2% by mass, the release of moisture from grated daikon radish after thawing cannot be suppressed, and if the amount is more than 10% by mass, viscosity (stickiness) occurs in grated daikon radish after thawing, resulting in impairment of texture.

In the method for thawing frozen grated daikon radish of the present invention, for example, the distarch phosphate and the hydroxypropyl distarch phosphate are preferably each added in the range of 1 to 5% by mass with respect to the entire amount of the frozen grated daikon radish.

### DETAILED DESCRIPTION OF THE INVENTION

Next, an embodiment of the present invention will be described in further detail.

A method for thawing frozen grated daikon radish of the present embodiment is a method for thawing frozen grated daikon radish formed by freezing grated daikon radish that is obtained by grating a root portion of a daikon radish and retains a predetermined moisture content, wherein when the frozen grated daikon radish is thawed, distarch phosphate and hydroxypropyl distarch phosphate are added in the range of 2 to 10% by mass in total with respect to the entire amount of the frozen grated daikon radish.

The frozen grated daikon radish can be produced, for example, as follows. First, daikon radishes grown under contract with the cultivator are conveyed to a factory, where the root portions, with leaves, root ends, and other unnecessary parts removed, are washed, peeled, and immersed in a diluted sterilizing solution (aqueous hypochlorous acid solution) for sterilization. Next, the sterilized root portions are grated with a food cutter (manufactured by Urschel Laboratories Inc., trade name: Comitrol head) to obtain grated daikon radish that has been subdivided into small pieces.

The grated daikon radish thus obtained contains about 98% by mass of moisture, although this may vary to some degree depending on the season, place of production, and other factors. Then, by draining the grated daikon radish and removing excess moisture, grated daikon radish having, for example, a solid content of 65% by mass and a liquid content of 35% by mass is obtained. Next, the drained grated daikon radish is frozen according to a conventional method, thereby obtaining frozen grated daikon radish.

In the method for thawing frozen grated daikon radish of the present embodiment, when the frozen grated daikon radish produced as described above is transferred to tableware or a container such as a sealable plastic container, and thawed naturally or by cold water thawing, etc., the frozen grated daikon radish is thawed naturally or by cold water thawing, etc., with the addition of distarch phosphate and hydroxypropyl distarch phosphate in the range of 2 to 10% by mass in total, for example, 3% by mass each of distarch phosphate and hydroxypropyl distarch phosphate, with respect to the entire amount of the frozen grated daikon radish.

The distarch phosphate is processed starch (trade name: INSTANT TEXTAID A) made from tapioca originating from Thailand, and can be obtained from Ingredion Japan K.K. (distributor). Also, the hydroxypropyl distarch phosphate is processed starch made from tapioca and waxy corn originating from Thailand (trade name: IF 131) or processed starch made from tapioca originating from Thailand (trade name: NATIONAL 104), both of which can be obtained from Ingredion Japan K.K. (distributor).

Note that, in the method for thawing frozen grated daikon radish of the present embodiment, “when . . . is thawed” may mean immediately before starting the natural thawing or cold water thawing, etc., or at any point between the start and the end of the natural thawing or cold water thawing, etc.

Next, examples of the present invention and a comparative example are shown.

### REFERENCE EXAMPLE

In the present reference example, first, daikon radishes grown under contract with the cultivator were conveyed to a factory, where the root portions, with leaves, root ends, and other unnecessary parts removed, are washed, peeled, and immersed in a diluted sterilizing solution (aqueous hypochlorous acid solution) for sterilization. Next, the sterilized root portions were grated with a food cutter (manufactured by Urschel Laboratories Inc., trade name: Comitrol head) to obtain grated daikon radish that had been subdivided into small pieces. Then, by draining the grated daikon radish and removing excess moisture, grated daikon radish having a solid content of 65% by mass and a liquid content of 35% by mass was obtained.

Next, the drained grated daikon radish was transferred to a container and frozen according to a conventional method to produce frozen grated daikon radish.

Next, to 82 parts by mass of the frozen grated daikon radish accommodated in the container, 15 parts by mass of indigestible dextrin (manufactured by Ingredion Japan K.K.) and 3 parts by mass of distarch phosphate (distributor: Ingredion Japan K.K., trade name: INSTANT TEXTAID A) were added to make the entire amount 100 parts by mass, and then the frozen grated daikon radish was thawed naturally.

Note that the indigestible dextrin is intended to adjust the amount of the additive added to the frozen grated daikon radish, and does not have any effect of suppressing the release of moisture when the frozen grated daikon radish is thawed, or any effect of preventing impairment of texture of grated daikon radish after thawing due to viscosity (stickiness).

Next, the naturally thawed grated daikon radish was transferred to a stainless steel plain weave 16 mesh colander and the mass of released moisture was weighed. Then, the mass of moisture released from grated daikon radish after thawing by the thawing method of the present reference example was defined as 100, which was used as the standard for the proportion of moisture released from grated daikon radish after thawing by the thawing methods of the examples and comparative example (water release proportion). In addition, the grated daikon radish thawed by the thawing method of the present reference example was not viscous (sticky) and had excellent texture. The results are shown in Table 1.

### Example 1

In the present example, to 82 parts by mass of the frozen grated daikon radish that had been produced in exactly the same manner as in the reference example and accommodated in the container, 12 parts by mass of indigestible dextrin (manufactured by Ingredion Japan K.K.), 3 parts by mass of distarch phosphate (distributor: Ingredion Japan K.K., trade name: INSTANT TEXTAID A), and 3 parts by mass of hydroxypropyl distarch phosphate (distributor: Ingredion Japan K.K., trade name: IF 131) were added to make the entire amount 100 parts by mass, and then the frozen grated daikon radish was thawed naturally.

Next, the naturally thawed grated daikon radish was transferred to a stainless steel plain weave 16 mesh colander and the mass of released moisture was weighed. The proportion (water release proportion) with respect to the moisture released from grated daikon radish thawed by the thawing method of the reference example was calculated. In addition, the grated daikon radish thawed by the thawing method of the present example was not viscous (sticky) and had excellent texture. The results are shown in Table 1.

### Example 2

In the present example, to 82 parts by mass of the frozen grated daikon radish that had been produced in exactly the same manner as in the reference example and accommodated in the container, 12 parts by mass of indigestible dextrin (manufactured by Ingredion Japan K.K.), 3 parts by mass of distarch phosphate (distributor: Ingredion Japan K.K., trade name: INSTANT TEXTAID A), and 3 parts by mass of hydroxypropyl distarch phosphate (distributor: Ingredion Japan K.K., trade name: NATIONAL 104) were added to make the entire amount 100 parts by mass, and then the frozen grated daikon radish was thawed naturally.

Next, the naturally thawed grated daikon radish was transferred to a stainless steel plain weave 16 mesh colander and the mass of released moisture was weighed. The proportion (water release proportion) with respect to the moisture released from grated daikon radish thawed by the thawing method of the reference example was calculated. In addition, the grated daikon radish thawed by the thawing method of the present example was not viscous (sticky) and had excellent texture. The results are shown in Table 1.

### COMPARATIVE EXAMPLE

In the present comparative example, to 82 parts by mass of the frozen grated daikon radish that had been produced in exactly the same manner as in the reference example and accommodated in the container, 15 parts by mass of indigestible dextrin (manufactured by Ingredion Japan K.K.) and 3 parts by mass of carboxymethyl cellulose (manufactured by Daicel Chemical Industries, Ltd., trade name: CMC 1181) were added to make the entire amount 100 parts by mass, and then the frozen grated daikon radish was thawed naturally.

Next, the naturally thawed grated daikon radish was transferred to a stainless steel plain weave 16 mesh colander and the mass of released moisture was weighed. The proportion (water release proportion) with respect to the moisture released from grated daikon radish thawed by the thawing method of the reference example was calculated. In addition, the grated daikon radish thawed by the thawing method of the present comparative example was viscous (sticky) and had impaired texture. The results are shown in Table 1.

Note that, in Table 1, distarch phosphate (distributor: Ingredion Japan K.K., trade name: INSTANT TEXTAID A) is referred to as “Processed starch A”, hydroxypropyl distarch phosphate (distributor: Ingredion Japan K.K., trade name: IF 131) is referred to as “Processed starch B”, hydroxypropyl phosphate (distributor: Ingredion Japan K.K., trade name: NATIONAL 104) is referred to as “Processed starch C”, and carboxymethyl cellulose is referred to as “CMC”.

TABLE 1

| | | Reference | | | Comparative |
|---|---|---|---|---|---|
| | | Example | Example 1 | Example 2 | Example |
| Frozen grated daikon radish | (parts by mass) | 82 | 82 | 82 | 82 |
| Indigestible dextrin | (parts by mass) | 15 | 12 | 12 | 15 |
| Processed starch A | (parts by mass) | 3 | 3 | 3 | — |
| Processed starch B | (parts by mass) | — | 3 | — | — |
| Processed starch C | (parts by mass) | — | — | 3 | — |
| CMC | (parts by mass) | — | — | — | 3 |
| Water release proportion | | 100 | 31 | 1 | 85 |
| Stickiness | | Absent | Absent | Absent | Present |

From Table 1, it is clear that, according to the methods for thawing frozen grated daikon radish of Examples 1 and 2, the proportion of moisture released from the thawed grated daikon radish (water release proportion) is lower compared to that of the method for thawing frozen grated daikon radish of the comparative example, and that grated daikon radish that is not viscous (sticky) and has excellent texture can be obtained even when the 10 amount of distarch phosphate and hydroxypropyl distarch phosphate added is larger than that of carboxymethyl cellulose.

1. A method for thawing frozen grated daikon radish formed by freezing grated daikon radish that is obtained by grating a root portion of a daikon radish and retains a predetermined moisture content,
wherein when the frozen grated daikon radish is thawed, distarch phosphate and hydroxypropyl distarch phosphate are added in a range of 2 to 10% by mass in total with respect to an entire amount of the frozen grated daikon radish.

2. The method for thawing frozen grated daikon radish according to claim 1, wherein the distarch phosphate and the hydroxypropyl distarch phosphate are each added in a range of 1 to 5% by mass with respect to the entire amount of the frozen grated daikon radish.
